(19) United States
(12) Patent Application Publication
(10) Pub. No.: US 2014/0358697 A1
(43) Pub. Date: Dec. 4, 2014

(54) AUTOMATED SUPPRESSION OF CONTENT DELIVERY

(71) Applicant: ZIPPIT LLP, London (GB)

(72) Inventors: Russell IRWIN, London (GB); Geo CARNCROSS, London (GB)

(73) Assignee: ZIPPIT LLP, London (GB)

(21) Appl. No.: 13/909,006

(22) Filed: Jun. 3, 2013

(51) Int. Cl. G06Q 30/02

(52) U.S. Cl. CPC G06Q 30/0275
USPC 705/14.71

(57) ABSTRACT

Automated bidding for advertisement suppression is described, for example, to enable a user to pay to skip advertisements by using a bidding agent to act on behalf of the user in an auction for advertisement opportunities. In various examples, where the bidding agent wins the auction on behalf of the user, no advertisement, or an unobtrusive blank advertisement, is presented. In some examples the bidding agent is a web service with access to data about pre-registered end user devices and associated bid configurations and histories. In examples the bidding agent receives a bid request, identifies an associated registered end user device and bid configuration, and places a bid in an auction for an advertisement opportunity. In some examples, when the bidding agent wins the auction, the bidding agent enables either a publisher or the end user device to skip advertisements. For example, by providing a decryption key.

### BACKGROUND

Showing advertisements during breaks in television program broadcasts has been, and is still, widely used. For example, a television broadcaster may sell advertisement opportunities according to fixed prices or by auction. Advertisement opportunities are increasingly sold for many situations where end users view on-line or pre-recorded content or use software applications. For example, where an end user views video content provided at an internet site advertisement breaks may be made. Other examples include internet radio, connected television, display advertisements, in-application advertisements and others. Connected television may be television content that solely accessed via the internet or other web-based communications networks or has at least a partial on-line internet based component, for example an interactive component Display advertisements are advertisements displayed at web sites for example, by the side of or next to content that a user is browsing. In-application advertisements are advertisements that are displayed within an interface of a software application that a user is operating. For example, a game, an email application, a photo editing application.

Where advertisements become overly intrusive, end users may desire to suppress or skip advertisements. Previous approaches have involved recording and/or offsetting of content streams to enable advertisements to be skipped. However, it has been difficult to enable end users to have fine grained control of advertisement suppression without increasing complexity unduly.

The embodiments described below are not limited to implementations which solve any or all of the disadvantages of known advertisement suppression processes and equipment.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Automated bidding for advertisement suppression is described, for example, to enable a user to pay to skip advertisements by using a bidding agent [zippit server] to act on behalf of the user in an auction for advertisement opportunities. In various examples, where the bidding agent wins the auction on behalf of the user, no advertisement, or an unobtrusive blank advertisement, is presented. In some examples the bidding agent is a web service with access to data about pre-registered end user devices and associated bid configurations and histories. In examples the bidding agent receives a bid request, identifies an associated registered end user device and bid configuration, and places a bid in an auction for an advertisement opportunity. In some examples, when the bidding agent wins the auction, the bidding agent enables either a publisher or the end user device to skip advertisements. For example, by providing a decryption key or in other ways.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a bidding agent, a publisher/broadcaster and an end user device which may be used together to enable advertisement suppression;

FIG. 2 is a flow chart of an example method of advertisement suppression using a supply side platform and a demand side platform;

FIG. 3 is a flow chart of methods of advertisement suppression for connected TV, in-stream audio and other situations;

FIG. 4 is a flow chart of a method of advertisement suppression where a bidding agent and auction mechanism are integral;

FIG. 5 is a flow chart of a method of enrolling an end user device at a bidding agent;

FIG. 6 is an example graphical user interface display for site history provided by a bidding agent;

FIG. 7 is an example graphical user interface display for bid configuration provided by a bidding agent;

FIG. 8 is an example of advertisement skipping for offline content;

FIG. 9 illustrates an exemplary computing-based device in which embodiments of a bidding agent and/or advertisement skipping components for use at a publisher or an end user device may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

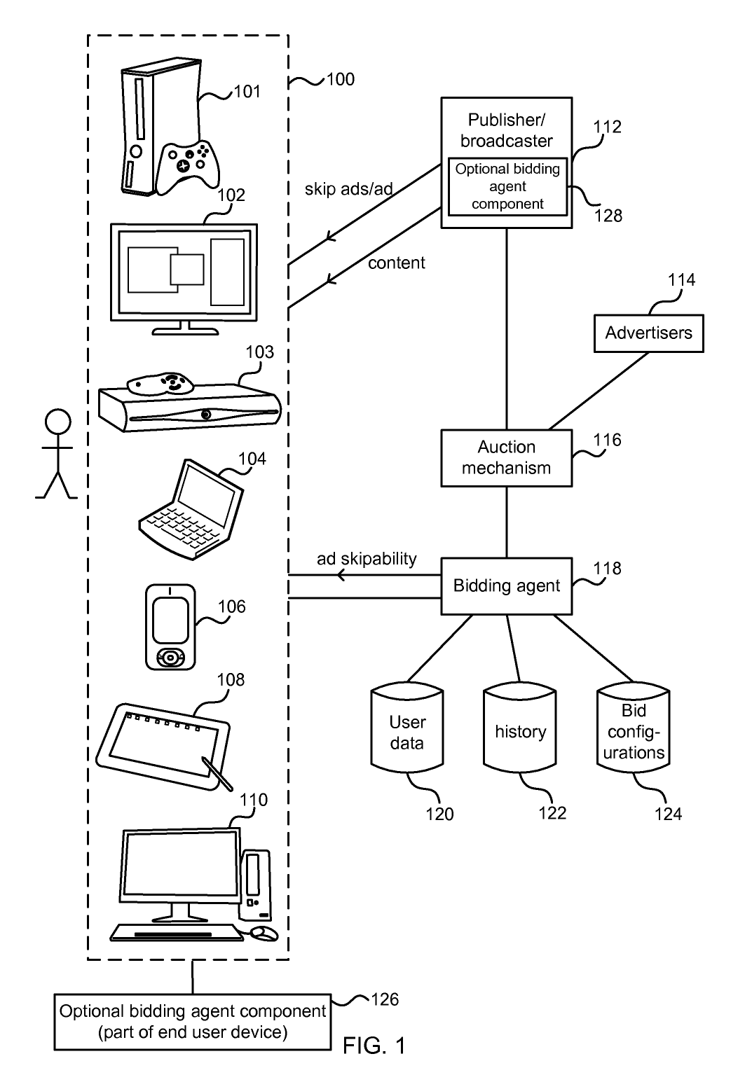

FIG. 1 is a schematic diagram of a bidding agent 118, a publisher/broadcaster 112 and an end user device 100 which may be used together to enable advertisement suppression. The end user device 100 may be a game system with console 101, connected television 102, a cable-TV box 103, a laptop computer 104, a mobile phone 106, a tablet computer 108, a personal computer 110 or any other computing device which is able to receive and display content and to communicate with a bidding agent.

The end user device 100 is arranged to receive and display content from one or more publishers 112. Only one publisher 112 is shown in FIG. 1 but in practice many publishers may be present. Each publisher 112 is computer implemented using software and/or hardware and in some examples a publisher 112 may be a broadcaster of live content. The content is published by the publisher 112 by making the content available at a web site from which end user devices 100 are able to access the content. In some examples the content is published in encrypted form and the end user device comprises functionality to decrypt the content.

The bidding agent 118 is also computer implemented using software and/or hardware. For example, the bidding agent 118 may comprise one or more web servers arranged to provide a web service which involves acting on behalf of the user in an auction for advertisement opportunities. Where the bidding agent wins the auction on behalf of the user, no advertisement, or an unobtrusive blank advertisement, may be presented at the user's device or devices. The functionality to skip advertisements in this manner may be provided at any one or more of: the end user device 100, the publisher 112 or another entity in communication with the publisher or end user device.

The bidding agent 118 may comprise a web-based interface accessible by end user devices 100 and arranged to enable end users to enroll with the web-service, to set bid configurations, to view history (comprising data about past use of the web service) and for other purposes. The bidding agent 118 has access to one or more data stores such as databases or other records holding user data 120, web service history 122, and bid configurations 124. A bid configuration is a plurality of parameter value ranges, criteria, thresholds or other data relating to how one or more users desire to bid in an auction for advertisement opportunities.

The bidding agent 118 is in communication with one or more auction mechanisms 116 (one auction mechanism is shown in FIG. 1 although more may be present in practice). In some examples the auction mechanism is part of the bidding agent 118. An auction mechanism is computer implemented using software and/or hardware. It is able to receive bids (from at least two different parties) for an auction, calculate a winner of the auction according to auction rules, and to output an outcome of the auction. Different types of auction may be implemented by the auction mechanism. A non-exhaustive list of example is: one shot auctions; multi-round auctions; forward or reverse (Dutch) auctions; auctions using a dynamic or static floor price; click-to-bid auctions.

One or more advertisers 114 (which are computer implemented entities controlled by entities desiring to purchase advertisement opportunities) are in communication with the auction mechanism 116 and are able to place bids for advertisement opportunities.

It is possible for a publisher to act as an end user device in addition to acting as a publisher.

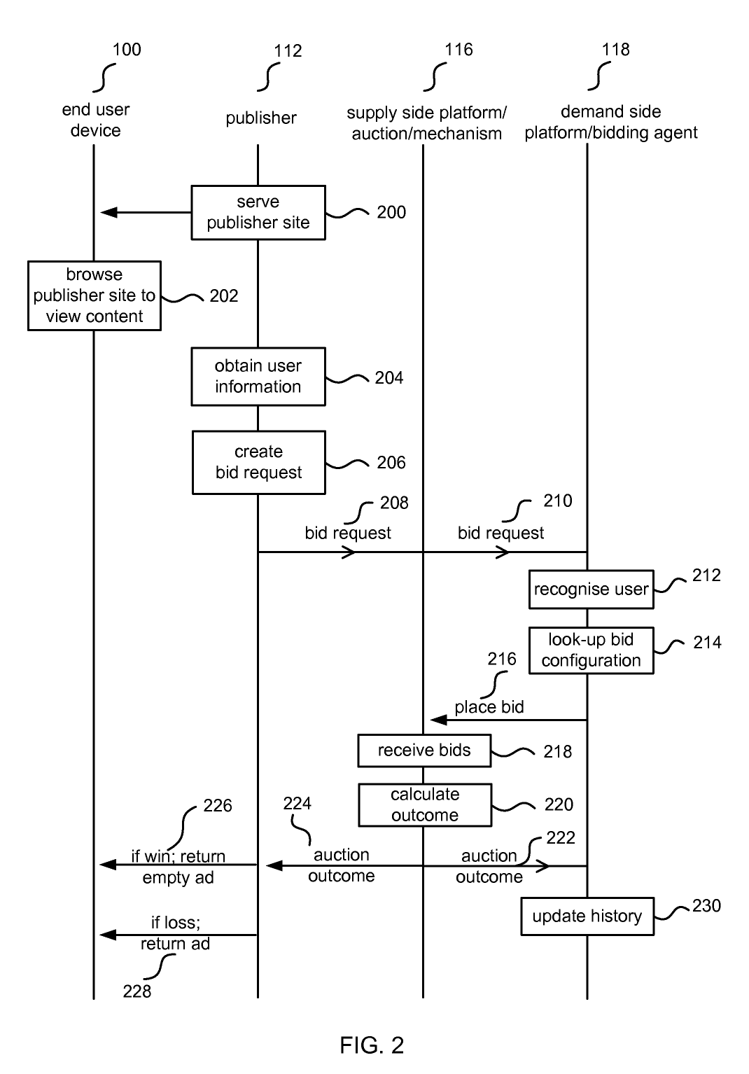

FIG. 2 is a flow chart of an example method of advertisement suppression using a supply side platform to implement the auction mechanism (see 116 of FIG. 1) and a demand side platform to implement the bidding agent 118. Each of the advertisers 114 may also comprise a demand side platform. Each of the vertical lines in FIG. 2 represents an entity so that an end user device 100, a publisher 112, a supply side platform/auction mechanism 116 and a demand side platform/bidding agent 118 are represented. Arrows between the lines represent communication events between the entities and the relative position of the arrows represents the chronological order of the events.

In the example of FIG. 2 a publisher 112 serves 200 a publisher web site to an end user device 100 at which a user browses 202 the publisher site to view content. In an example the publisher may serve 200 the publisher web-site to the end user device 100 in response to a request from the end user device for publisher content, for example an on demand request.

In this example the publisher obtains 204 user device information (where the user has registered with the bidding agent and given consent). For example, the publisher receives cookies from the end user device or detects an IP address of the end user device. In other examples the publisher obtains 204 information about the end user device 100 by obtaining a device id or SIM (subscriber identification component) data.

The publisher 112 in this example comprises a bidding agent component 128. This component is arranged to create 206 a bid request each time a user begins to view content at the publisher site (whether that user is registered with the bidding agent service or not). A bid request is a message comprising a destination address (address of the bidding agent), an address or other identifier of the publisher site being browsed, the obtained user device information, and how many advertisement display opportunities are present at the publisher site (for example, there may be a video in one region of a display and a second region available on the same display).

The publisher 112 sends 208 the bid request to the supply side platform using any suitable communications protocol such as TCP, HTTP or any other suitable communications channel. The supply side platform forwards 210 the bid request to the bidding agent.

The bidding agent uses the data from the bid request to check that it recognizes 212 the user. If the user is enrolled with the bidding agent service the user device has a user device profile and history which the bidding agent is able to access from databases 120, 122. If the bidding agent does not recognize the user, or if the user account is blocked then the bidding agent takes no further action. If the bidding agent recognizes the user it proceeds to look up the bid configuration 214 of the user device. Bid configurations are described in more detail later in this document. In an example where the optional bidding agent component 124 is installed on the end user device 100 the bidding agent may be able to recognize the user prior to the publisher obtaining user information 204.

The bidding agent uses the bid configuration and knowledge of the auction mechanism 116 (such as the particular auction rules being used) to calculate a bid. It places 216 the bid by sending a message to the supply side platform. The supply side platform receives 218 bids from advertisers for the opportunity to display advertisements at the end user device as the publisher site is browsed. The supply side platform calculates 220 an outcome of the auction. In a first example the supply side platform sends 222 the auction outcome to the bidding agent which updates 230 the history. In an alternative example (not shown in FIG. 2) the auction outcome may not be sent from the supply side platform as shown in step 222 but may be embedded as a tracking pixel in an empty advertisement. In the first example the notification may be faster, however, fraud detection or implementation mistakes may be easier to detect in the second example. The supply side platform also sends 224 the auction outcome to the bidding agent interaction component at the publisher.

In the event that the bidding agent won the auction on behalf of the user, the publisher returns one or more empty advertisements to the end user device 100. If the bidding agent lost the auction on behalf of the user, the publisher returns one or more advertisements associated with the winning advertiser.

In some examples the empty advertisements are transparent to the end user so that the viewing experience is not interrupted. In other examples the empty advertisements are insignificant but visible to the user so that the user is aware of the success of the bidding agent service.

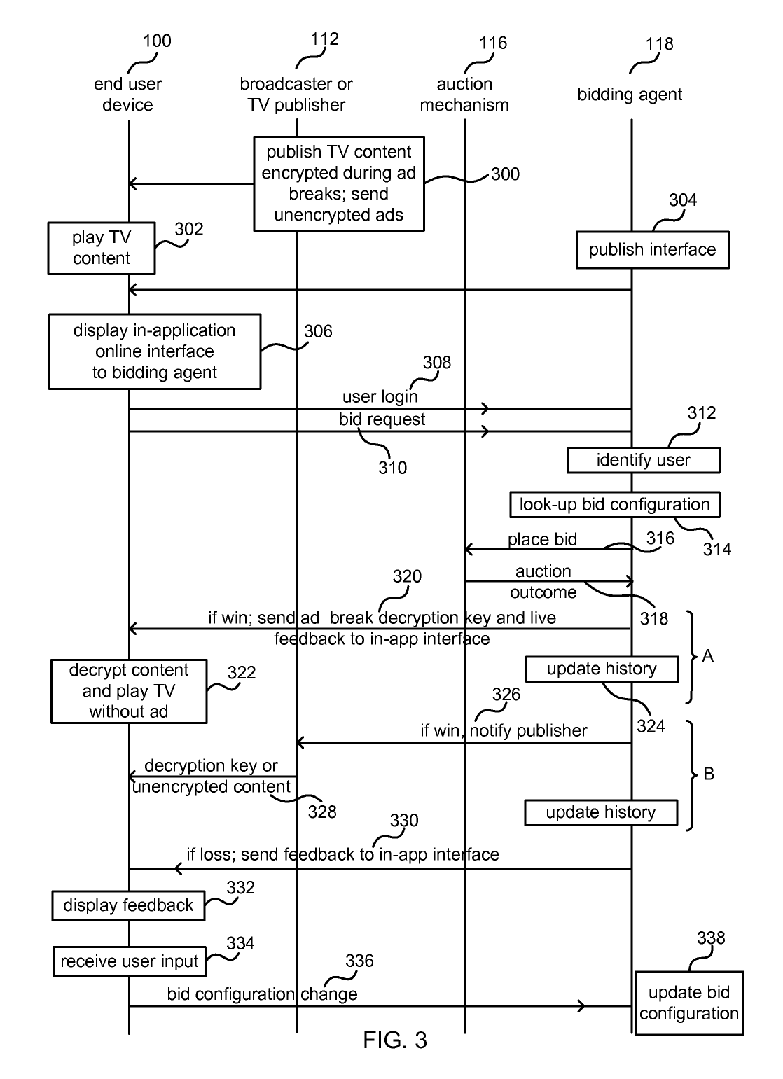

FIG. 3 is a flow chart of methods of advertisement suppression for connected TV, in-stream audio and other situations. As in FIG. 2 each of the vertical lines represents an entity so that an end user device 100, a broadcaster or TV publisher 112, an auction mechanism 116 and a bidding agent 118 are represented. Arrows between the lines represent communication events between the entities and the relative position of the arrows represents the chronological order of the events.

In this example, a connected TV publisher, sends TV content to an end user device 100 where it is played 302. In an example the TV publisher may send TV content to the end user device 100 in response to a request from the end user device for TV content, for example an on demand TV content request. The TV content may be encrypted 300 during advertisement breaks. During the advertisement breaks the connected TV publisher (or another entity) sends unencrypted advertisement to the end user device 100 which are displayed at the end user device during the advertisement break.

A bidding agent 118 publishes an interface 304 to the bidding agent service. At the end user device the interface is displayed as an in-application online interface to the bidding agent. For example, a software application at the end user device which is used to play the TV content comprises a component or component (optional bidding agent component 126 of FIG. 1) which browses the bidding agent interface and displays that as part of the software application.

An end user is able to submit a user login 308 request to the bidding agent 118 using the bidding agent interface displayed at the device. A bid request is sent 310 from the device to the bidding agent using the bidding agent interface. The bid request comprises an address or other identifier of the publisher site being browsed and user device information. In another example, the login 308 request may have occurred in advance and is not repeated, for example, the device may store details of a previous user login so that this step does not have to be repeated.

The bidding agent identifies 312 or recognizes the user by checking the user device information against the user profile associated with the user login. The bidding agent looks 314 up the bid configuration of the user device. It calculates a bid using the bid configuration and knowledge of the auction mechanism 116. The bidding agent 118 places 316 a bid by sending a message to the auction mechanism. It receives 318 an auction outcome.

In some examples, indicated by bracket A in FIG. 3, the bidding agent sends 320 a decryption key direct to the end user device in the event that the bidding agent won the auction for the end user device. The end user device comprises a decryption component which is arranged to use the decryption key to decrypt the TV content during the advertisement break(s). In this way the end user device is able to decrypt the content and play 322 the TV program without advertisement breaks. The bidding agent 118 is also able to send live feedback about the outcome of the auction to the end user device for display at the in-application online interface to the bidding agent.

In another example, indicated by bracket B in FIG. 3, the bidding agent sends 326 a win notification to the publisher 112 rather than to the end user device. In this situation a bidding agent interaction component at the publisher is able to send 328 either a decryption key or unencrypted content to the end user device. The end user device uses the decryption key to skip advertisements as described above.

In the event that the bidding agent loses the auction, the bidding agent is able to send feedback to the in-application online interface to the bidding agent at the end user device. For example, the feedback may display 332 to the user the fact that the auction was lost and give examples of bid amounts that have been successful in the past for similar situations. In another embodiment a lost bid may be derived by recording bids and subtract the winning bids. User input may be received 334 at the in-application online interface. For example, the user input may be a bid configuration change 336 which increases the bid. The bid configuration change is used at the bidding agent to update 338 the stored bid configuration.

The bidding agent 118 is arranged to update 324 the history after each auction outcome.

Although FIG. 3 has been described above with reference to connected TV, the methods of FIG. 3 are also suitable where the publisher is an internet radio broadcaster sending in-stream audio.

The examples described with respect to FIG. 3 may be modified by using different methods of recognizing the end user device 100 such as those described with reference to FIG. 2.

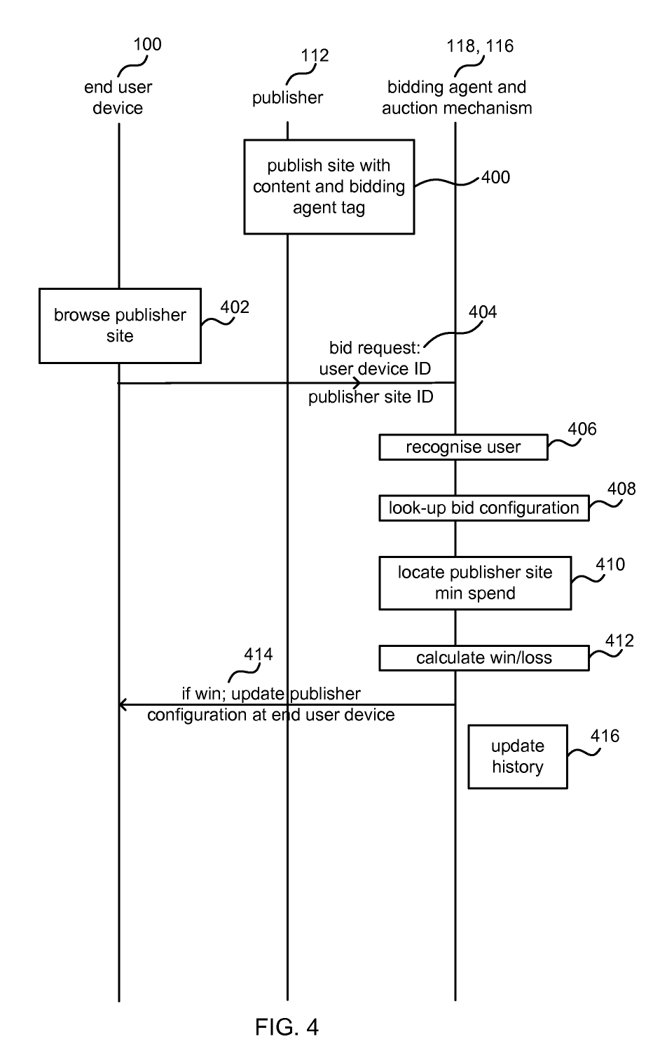

FIG. 4 is a flow chart of a method of advertisement suppression where a bidding agent 118 and auction mechanism 116 are integral. As for FIG. 3 each of the vertical lines represents an entity so that an end user device 100, a publisher 112, and a combined auction mechanism and bidding agent 116,118 are represented. Arrows between the lines represent communication events between the entities and the relative position of the arrows represents the chronological order of the events.

The example of FIG. 4 is useful for situations where a publisher guarantees to an end user that he or she has the ability to win the auction because only the publisher and the bidding agent participate in the auction. The auction mechanism may be integral with the bidding agent in this example because only the publisher and the bidding agent place bids.

In an example, the publisher 112 publishes 400 a web site with content to be viewed by an end user. The publisher 112 has previously enrolled on the bidding agent service. The publisher web site comprises a bidding agent tag or other marker comprising an identifier of the publisher web site (which is known to the bidding agent service through the enrollment process) and an address of the bidding agent.

The end user device 100 is used to browse 402 the publisher site in order that an end user may view the content. In some examples, the publisher detects the advertising opportunity and generates a bid request comprising a user device identifier and an identifier of the publisher site. In other examples the end user device has a browser plug-in which is triggered by the bidding agent tag presence to generate and send 404 a bid request to the bidding agent. In other examples the end user device has an in-application online interface to the bidding agent which is triggered by the bidding agent tag presence to generate and send a bid request to the bidding agent.

The bidding agent recognizes the user 406 as described above with reference to FIGS. 2 and 3. It looks up 408 the bid configuration associated with the end user device. The bidding agent locates 410 a publisher site minimum spend for the publisher site. For example, this information is provided by the publisher in the enrollment process. The publisher site minimum spend is a floor price above which the publisher guarantees to enable advertisement skipping. The bidding agent calculates 412 an outcome of an auction where the bid of the publisher is the publisher site minimum spend and the bid of the end user device is calculated from the bid configuration.

If the end user device wins the auction, the bidding agent sends messages to the end user device 100 to update 414 a publisher configuration at the end user device. The publisher configuration is updated to enable advertisements to be skipped for content published at the publisher site. If the end user device loses the auction, advertisements continue to be presented at the end user device.

The bidding agent updates 416 the history according to the auction outcome.

In some examples, the bidding agent tag at the publisher web site comprises a script or instructions comprising functions from an application programming interface (API) of the bidding agent. In examples where the end user device comprises a browser plug-in the browser-plug in notices the bidding agent tag and loads the instructions identified in the script. This enables the browser at the end user device to communicate with the bidding agent service and make bid requests.

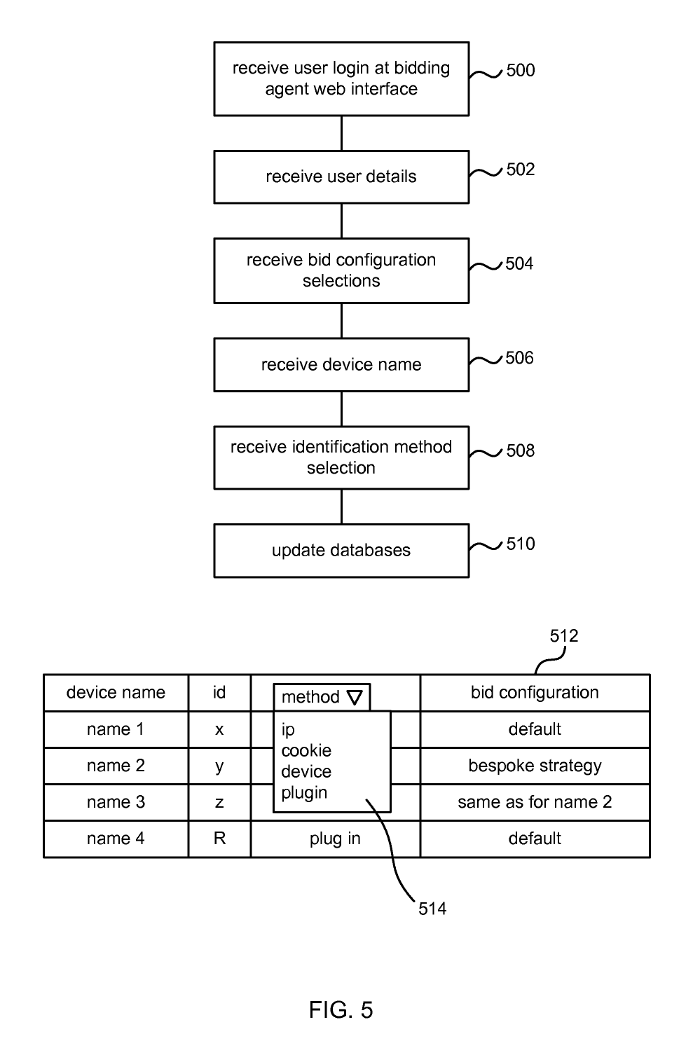

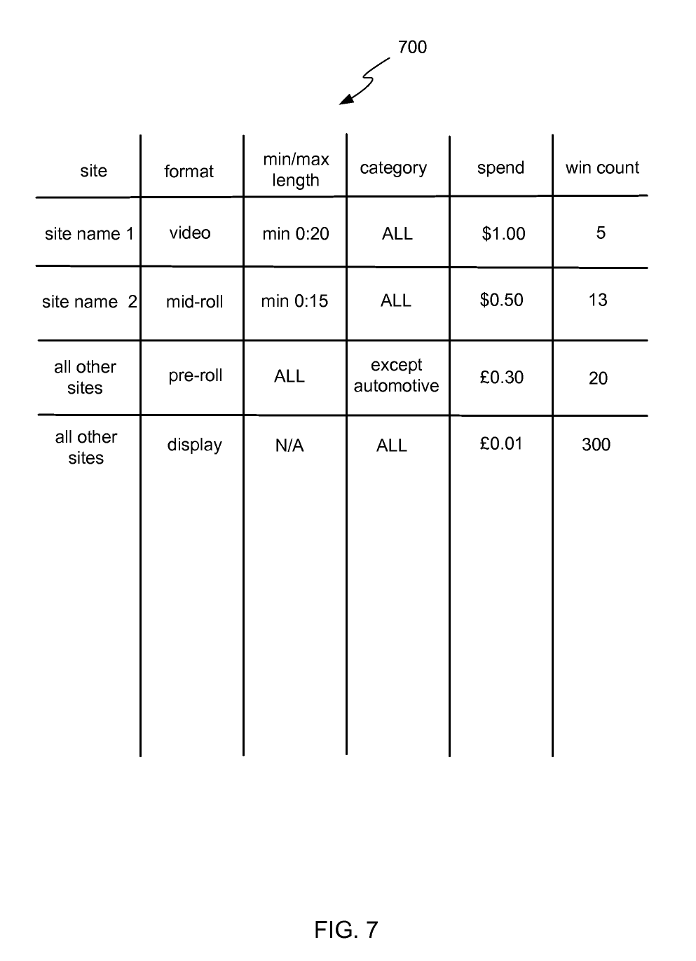

FIG. 5 is a flow chart of a method of enrolling an end user device at a bidding agent. Using a web browser at the end user device an end user browses the bidding agent web service. The user registers and logs in. The bidding agent receives 500 the user login and as part of the registration process receives 502 user details. These may comprise billing information, credit details, name and address and other user details. The bidding agent receives and stores bid configuration selections 504 for one or more devices associated with the user. The example in FIG. 5 shows an enrollment table 512 for a single user who has four end user devices registered with the service. Each device is represented by a row in the table. The bid configuration selections indicate whether a default bid configuration, a bespoke bid configuration or a previous bid configuration are to be used for a particular device. One or more different default bid configurations may be available for different content viewing scenarios and/or end user requirement categories. A bespoke bid configuration is one which is set up by a user as described in more detail with reference to FIG. 7.

A device name is received 506 (which may be input by the user or selected by the bidding agent) for each end user device a user registers with the service. The bidding agent also receives 508 an identification method selection for each end user device a user registers with the service. The identification method may be any of: detect IP address of end user device, obtain cookies from the end user device, obtain a SIM identifier or telephone number of the end user device, use a bidding agent component (such as a browser plugin or other component) at the end user device. The bidding agent stores the selections and data it receives by updating 510 databases 120, 124 of FIG. 1. In an embodiment selections and data received may be passed between two or more of the end user device, the bidding agent and the publisher as opaque strings so that the bidding agent may be able to verify a user but no information collected by the publisher at bid time is revealed.

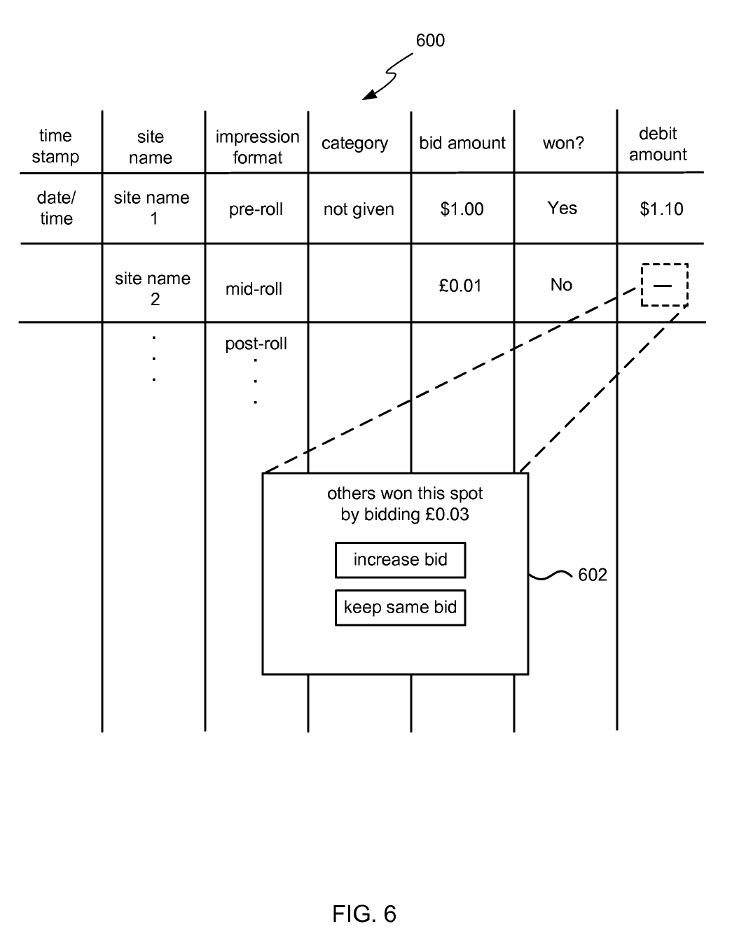

FIG. 6 is an example graphical user interface display 600 for site history provided by a bidding agent. For example, this type of graphical user interface may be browsed at an end user device using a web browser which may be part of an in-application online interface to the bidding agent. The display comprises a table where each row stores data about an auction outcome event. For example, the data may comprise any one or more of:

a time stamp for the event which may show a date and/or time;

a site name which is an identifier of a web site from which content was viewed and at which advertisement opportunities were available;

an impression format such as pre-roll, mid-roll, post-roll, all video, display, in-application, TV, audio, radio, offline, video game;

a category (this is used where the auction comprises multiple rounds);

a bid amount (the bid amounts may be in different currencies);

an auction outcome (such as yes or no, win or lose);

a debit amount (which may be more than the bid amount where the bidding agent service takes a commission).

A user is able to select a cell of the table to receive guidance and/or suggestions for future bid amounts. For example, selecting a cell of the table may cause a pop up display 602 to appear giving more detail about the event and requesting user input. In the example of FIG. 6 a second row of the table represents an auction event which was lost. A pop up display 602 associated with the debit amount cell indicates that others won in this situation by bidding £0.03 and giving the user buttons to enable his or her bid to be increased or not for future events with similar scenarios.

FIG. 7 is an example graphical user interface display 700 for bid configuration provided by a bidding agent. The bid configuration may be for a registered end user device of a member of the bidding agent service. The display comprises a table with a row for each site (or groups of sites) that an end user wishes to view content from whilst skipping advertisements. Each row comprises one or more features of advertisements it is desired to skip, a spend amount, and optionally a win count. A non-exhaustive list of examples of features of advertisements is: content type the advertisement will interrupt, position in time of the advertisement with respect to the content (e.g. pre-roll, mid-roll, post-roll), advertisement length, advertisement category (e.g. health, automotive). The spend amount may be a bidding amount. Where a win count column is available this provides feedback to users as to how their money is spent. By operating the graphical user interface a user is able to add, change or delete data in the bid configuration.

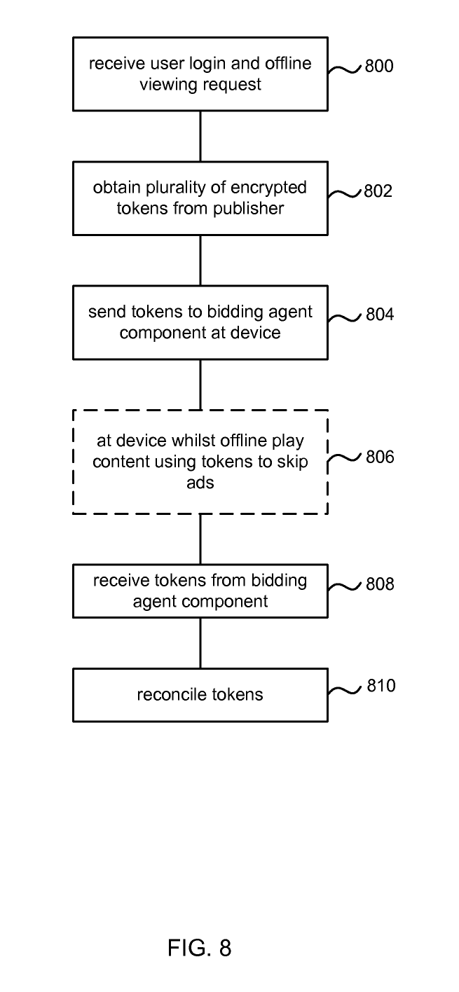

FIG. 8 is an example of advertisement skipping for offline content. For example, content may have been downloaded (together with advertisements) from a publisher site for offline viewing at the end user device. The dotted boxes in FIG. 8 represent processes which occur (at the end user device) whilst the end user device is offline, that is, unable to connect to the bidding agent and/or publisher. The solid boxes in FIG. 8 represent process which occurs (at the bidding agent) whilst the end user device is online.

The bidding agent receives 800 a user login and offline viewing request from the end user device. The offline viewing request comprises details of the publisher and content to be viewed offline. The bidding agent obtains 802 a plurality of encrypted tokens from the publisher and sends 804 those to a bidding agent component at the end user device. In some examples the tokens are time limited so that after a specified time they expire.

The end user device, whilst offline, is able to play the downloaded content and use the encrypted tokens to skip advertisements in the downloaded content. For example, the encrypted tokens may comprise decryption keys to decrypt content during advertisement breaks (as described above with reference to FIG. 3. In an example, offline may refer to a scenario in which internet accessible content and services are unavailable but live content may be available via terrestrial broadcast, satellite broadcast or other alternative forms of content streaming.

Once online again the bidding agent component at the end user device sends the tokens to the bidding agent. The bidding agent receives 808 the used tokens and reconciles those with the tokens provided by the publisher. As a result of the reconciliation the bidding agent debits the account associated with the end user device.

In an example, a method at a computer-implemented bidding agent comprises: receiving a login and offline viewing request from an end user device to view content published by a publisher at a publisher web site; obtaining a plurality of encrypted tokens from the publisher; sending the tokens to a bidding agent component at the end user device; receiving used tokens from the bidding agent component at the end user device and reconciling the used tokens with the tokens received from the publisher. In examples the tokens are time limited. In examples the tokens enable advertisements associated with the published content to be skipped.

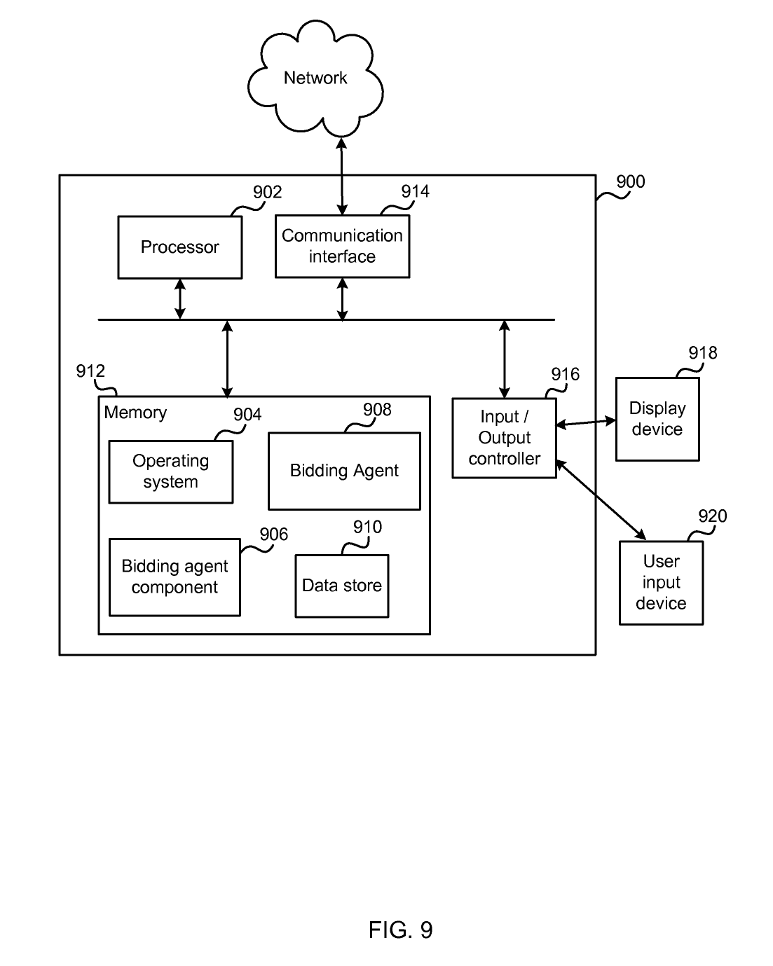

FIG. 9 illustrates various components of an exemplary computing-based device 900 which may be implemented as any form of a computing and/or electronic device, and in which embodiments of any of: a bidding agent, an end user device with a bidding agent component, a publisher with a bidding agent component, may be implemented.

Computing-based device 900 comprises one or more processors 902 which may be microprocessors, controllers or any other suitable type of processors for processing computer executable instructions to control the operation of the device in order to provide bidding agent functionality, or, in the case of a publisher or end user device, to communicate with a bidding agent in order to enable a end user to purchase advertisement opportunities in an auction so as to skip advertisements when playing content. In some examples, for example where a system on a chip architecture is used, the processors 902 may include one or more fixed function blocks (also referred to as accelerators) which implement a part of the method of any of FIGS. 2 to 8 in hardware (rather than software or firmware). Platform software comprising an operating system 904 or any other suitable platform software may be provided at the computing-based device to enable application software to be executed on the device. Software comprising a bidding agent 908 is provided in the case that the computing-based device 900 is a bidding agent. Software comprising a bidding agent component 906 is provided in the case that the computing-based device 900 is a publisher or an end user device.

The computer executable instructions may be provided using any computer-readable media that is accessible by computing based device 900. Computer-readable media may include, for example, computer storage media such as memory 912 and communications media. Computer storage media, such as memory 912, includes volatile and non-volatile, removable and non-removable media implemented in any method or technology for storage of information such as computer readable instructions, data structures, program components or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program components, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 912) is shown within the computing-based device 900 it will be appreciated that the storage may be distributed or located remotely and accessed via a network or other communication link (e.g. using communication interface 914).

The computing-based device 900 also comprises an input/output controller 916 arranged to output display information to a display device 918 which may be separate from or integral to the computing-based device 900. The display information may provide a graphical user interface. The input/output controller 916 is also arranged to receive and process input from one or more devices, such as a user input device 920 (e.g. a mouse, keyboard, camera, microphone or other sensor). In some examples the user input device 920 may detect voice input, user gestures or other user actions and may provide a natural user interface (NUI). This user input may be used to input bid configurations, enroll at a bidding agent, view bid history, enter user registration data or for other purposes. In an embodiment the display device 918 may also act as the user input device 920 if it is a touch sensitive display device. The input/output controller 916 may also output data to devices other than the display device, e.g. a locally connected printing device.

Any of the input/output controller 916, display device 918 and the user input device 920 may comprise NUI technology which enables a user to interact with the computing-based device in a natural manner, free from artificial constraints imposed by input devices such as mice, keyboards, remote controls and the like.

In some examples, the bidding agent is a content suppression server which may provide a service to enable a user device to control suppression of content to the device. The content suppression server may comprise:

a communications interface arranged to receive a content suppression request over a communications network, the content suppression request comprising at least data about an end user device and a publisher site identifier;

a processor arranged to recognize the end user device on the basis of the data;

the processor arranged to access a content suppression configuration associated with the recognized end user device, the content suppression configuration comprising values related to a user's propensity to suppress content;

the processor arranged to calculate a propensity value using the accessed content suppression configuration and the publisher site identifier;

an interface to an automated resolution mechanism, the interface arranged to send the propensity value to the automated resolution mechanism and to receive an outcome indicating whether content delivery is to be suppressed.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A content suppression server comprising:
a communications interface arranged to receive a content suppression request over a communications network, the content suppression request comprising at least data about an end user device and a publisher site identifier;
a processor arranged to recognize the end user device on the basis of the data;
the processor arranged to access a content suppression configuration associated with the recognized end user device, the content suppression configuration comprising values related to a user's propensity to suppress content;
the processor arranged to calculate a propensity value using the accessed content suppression configuration and the publisher site identifier;
an interface to an automated resolution mechanism, the interface arranged to send the propensity value to the automated resolution mechanism and to receive an outcome indicating whether content delivery is to be suppressed.

2. A method at a bidding agent comprising:
receiving a bid request over a communications network, the bid request comprising at least data about an end user device and a publisher site identifier, the bid request being associated with at least one advertisement opportunity related to content published at the publisher site and to be viewed at the end user device;
recognizing the end user device on the basis of the data;
accessing a bid configuration associated with the recognized end user device, the bid configuration comprising bid amounts;
calculating a bid using the accessed bid configuration and the publisher site identifier;
sending the bid to an automated auction mechanism to bid for the at least one advertisement opportunity in an auction on behalf of a user associated with the end user device.

3. A method as claimed in claim 1 comprising obtaining an outcome of the auction and, if the outcome is a win by the bidding agent, sending an advertisement break decryption key to the end user device.

4. A method as claimed in claim 1 comprising obtaining an outcome of the auction and, if the outcome is a win by the bidding agent, sending a message to notify a publisher associated with the publisher site identifier.

5. A method as claimed in claim 2 comprising sending live auction outcome feedback to an in-application online interface to the bidding agent at the end user device.

6. A method as claimed in claim 3 comprising sending historical auction outcome data to the in-application online interface at the end user device.

7. A method as claimed in claim 1 comprising receiving additions, changes or deletions to the bid configuration from an in-application online interface to the bidding agent at the end user device.

8. A method as claimed in claim 1 comprising sending the bid to the auction mechanism which is at the bidding agent, obtaining a publisher site minimum spend and calculating the auction outcome using the bid configuration and the publisher site minimum spend.

9. A method as claimed in claim 6 comprising, if the auction outcome is a win for the bidding agent, sending a message to the end user device to update a publisher configuration at the end user device.

10. A computer-implemented bidding agent comprising:
a communications interface arranged to receive a bid request over a communications network, the bid request comprising at least data about an end user device and a publisher site identifier, the bid request being associated with at least one advertisement opportunity related to content published at the publisher site and to be viewed at the end user device;
a processor arranged to recognize the end user device on the basis of the data;
the processor arranged to access a bid configuration associated with the recognized end user device, the bid configuration comprising bid amounts;
the processor arranged to calculate a bid using the accessed bid configuration and the publisher site identifier;
an interface to an automated auction mechanism, the interface arranged to send the bid to the automated auction mechanism to bid for the at least one advertisement opportunity in an auction on behalf of a user associated with the end user device.

11. A method at an end user device comprising:
executing a web-browser at the end user device to display content published at a publisher web site, the content having at least one associated advertisement;
making data about the end user device available to a bidding agent with which the end user device is registered such that the bidding agent is able to bid for the at least one associated advertisement in an automated auction; and
if the auction is won by the bidding agent, receiving, at a processor, any of: an empty advertisement, a decryption key, and a publisher configuration update;
using the empty advertisement, decryption key or publisher configuration update to skip the at least one associated advertisement at the end user device.

12. A method as claimed in claim 11 wherein using the empty advertisement to skip the at least one associated advertisement comprises displaying the empty advertisement in a manner noticeable to a user and which is insignificant.

13. A method as claimed in claim 11 wherein a decryption key is received and the method comprises decrypting part of the content associated with the advertisement.

14. A method as claimed in claim 11 wherein a publisher configuration update is received and the method comprises using the updated publisher configuration to receive content from the publisher web site in a manner which enables the advertisement to be skipped.

15. A method as claimed in claim 11 comprising executing an in-application online interface to the bidding agent at the end user device and sending a bid request to the bidding agent using the in-application online interface.

16. A method as claimed in claim 11 comprising receiving live auction outcome feedback from the bidding agent at the end user device and displaying the feedback at a graphical user interface at the end user device.

17. A method as claimed in claim 11 comprising detecting a bidding agent tag at the publisher site the tag comprising an address of the bidding agent.

18. A method as claimed in claim 11 comprising detecting a bidding agent tag at the publisher site, the tag comprising a script, and executing instructions from the script at the end user device in order to communicate with the bidding agent.

19. An end user device comprising:
a web-browser arranged to display content published at a publisher web site, the content having at least one associated advertisement;
a bidding agent component arranged to make data about the end user device available to a bidding agent with which the end user device is registered such that the bidding agent is able to bid for the at least one associated advertisement in an automated auction; and
the bidding agent component arranged to receive, if the auction is won by the bidding agent, any of: an empty advertisement, a decryption key, and a publisher configuration update;
the bidding agent component arranged to use the empty advertisement, decryption key or publisher configuration update to skip the at least one associated advertisement at the end user device.

20. A computer-implemented method at an automated publisher comprising:
publishing content and associated advertisements at a web site associated with the automated publisher;
obtaining data about an end user device executing a web browser to view the published content and advertisements;
creating a bid request comprising an identifier of the web site and the data;
sending the bid request to a bidding agent to enable the bidding agent to bid for at least one of the associated advertisements in an auction;
receiving an outcome of the auction;
if the outcome is a win for the bidding agent, sending any of: an empty advertisement, a decryption key, and a publisher configuration update to the end user device.

21. An automated publisher comprising:
a web server arranged to publish content and associated advertisements at a web site;
a bidding agent component arranged to obtain data about an end user device executing a web browser to view the published content and advertisements;
the bidding agent component arranged to create a bid request comprising the data and an identifier of the web site;
a communications interface arranged to send the bid request to a bidding agent to enable the bidding agent to bid for at least one of the associated advertisements in an auction; and to receive an outcome of the auction;
the bidding agent component arranged, if the outcome is a win for the bidding agent, to send any of: an empty advertisement, a decryption key, and a publisher configuration update to the end user device.
